(19) United States
(12) Patent Application Publication
(10) Pub. No.: US 2004/0011273 A1
(43) Pub. Date: Jan. 22, 2004

(54) Forward visual loading guide

(76) Inventor: Kurt W. Gorbutt, Port St. Lucie, FL (US)

Correspondence Address: Kurt W. Gorbutt, 1240 SE PALM BEACH ROAD, PORT ST LUCIE, FL, 34952, US

(21) Appl. No.: 10/417,512

(22) Filed: Apr. 18, 2003

Related U.S. Application Data
(60) Provisional application No. 60/377,803, filed on May 6, 2002.

(51) Int. Cl. B60P 3/10

(52) U.S. Cl. 114/344

(57) ABSTRACT

A forward visual reference device used during the boat to trailer drive-on loading process (Power Loading). It is a mechanical device designed to mount on a front portion of a boat trailer. The base of the device is mounted either on the trailer frame or on the vertical stanchion, depending on the particular boat/trailer configuration. Attached to the base is an adjustable member used to position the attached mast. The mast extends vertically above the bow of the boat and is adjusted to touch the tip of the bow when the boat is in its loaded position on the trailer. The driver of the boat now has a visual reference as to boat/trailer centering and visual reference when the boat is in loaded position (bow touches mast). The result is the boat may be single-handedly driven from the water onto the trailer to the loaded position without laborious winch cranking or reliance on “spotters” waving and yelling instructions.

### FIELD OF INVENTION

This invention relates to the process of loading a boat from the water onto a trailer. More specifically, it provides a trailer-mounted Forward Visual Loading Guide for the boat operator as he or she drives the boat onto the trailer. This type of “drive-on” loading is also known as “power loading”.

### BACKGROUND OF THE INVENTION

Recreational boating includes over 10 million registered vessels. The majority of these boats are trailer-transported to and from the water. Trailer boating requires launching from and loading onto the boat trailer. This invention relates to the loading process.

There are two methods to load a boat from the water onto the trailer. The first method is Manual Loading. This procedure requires pulling the boat onto the trailer using a winch and cable mounted at the front of the trailer. The downside is it is slow, labor intensive and requires the operator to walk on often an often slippery loading ramp surface. The second method is Power Loading. The invention is applicable to this method of loading. This procedure uses the boat engine power to drive the boat onto the trailer. It is faster, requires no manual labor and does not require the operator to walk on the aforementioned ramp surface. The disadvantages are as the boat moves onto the trailer, the boat operator loses all Forward Visual Reference of: 1) boat to trailer centering and 2) the stop (power off) point. If a person turns off the boat engine too soon, the boat will stop, and tends to “stick” on the trailer. Too much power application to start boat moving again can cause the boat to lurch forward and results in possible trailer and/or boat damage as the boat smashes into the bow cushion/stanchion.

The invention solves these Power Loading problems.

### DESCRIPTION OF PRIOR ART

There is only one system in use that provides the boat operator with any Forward Visual Reference regarding the boats position relative to the desired stop position. This involves another person standing on shore giving hand and voice signals. Unless both people are very familiar with each other's actions and reactions, the process is very crude and inefficient.

There are devices on the market that keep the boat centered on the trailer while loading. One is a vertical pole mounted to each side of the trailer at the rear. The other is horizontally mounted boards or rollers on each side of the trailer. See FIG. 2. With both systems, the operator aims the boat between the poles (or boards/rollers). These serve to keep the rear portion of the boat centered on the trailer. They do not offer any help centering the bow of the boat or judging distance to the stop point as the boat moves onto the trailer. Bow centering becomes guesswork when visual contact is lost with the front of the trailer. See FIG. 4.

A patent search was conducted and there are no devices found which provide a constant Forward Visual Guide during the entire loading process. I have visited countless marine/trailer supply stores and have not found any Forward Visual Guide devices on the market. I have many years of personal boating experience and have never seen any “homemade” devices on any boat trailer, which provide Forward Visual Guide.

### SUMMARY OF THE INVENTION

To clarify the intent and function of this invention, I offer the following which functionally describes the invention. Parking a car in a garage is an example. Most people have a hard time judging the “stop” point when pulling their car into the garage. To solve this problem many people use a “Forward Visual Reference” device in their garage. It consists of a ball suspended from the garage ceiling. The ball is hung so it touches the windshield when the car reaches the proper-parked position. Now, the driver can pull the car into the garage until the windshield touches the ball and stop the car before it hits the wall.

My invention serves the same function when driving a boat onto a trailer. The invention shows the operator how far he has to go until he reaches the proper loaded position of the boat and when to turn the boat engine off.

Boat trailers are equipped what will be referred to as a “vertical stanchion” (see FIG. 2). This is mounted to the trailer frame and serves two primary functions; 1) operator aiming point during “power loading” and, 2) hardware mounting. The cable/winch assembly is mounted to the stanchion. This assembly is used to manually winch the boat onto the trailer and secure the bow to keep the boat from sliding backward on the trailer. Also, there is a bow-stop cushion, which keeps the boat from sliding forward on the trailer. The stanchion and cushion placement determine the boats loaded (parked) position on the trailer. The stanchion is usually adjustable fore and aft to accommodate specific boats according to length and weight distribution. The cushion is usually adjustable up or down the stanchion to accommodate various bow styles.

The stanchion is the boat operators aiming point when moving the boat into position to load on the trailer (see FIG. 3). This works until the boat starts onto the trailer and the bow rises (see FIG. 4). At this time, the operator loses visual contact with the stanchion. His entire reference for both aim and distance to the stanchion is lost.

This is where the invention comes into use.

The invention consists of:

Base

Adjustable member

Mast

(See FIG. 1)

The Base is attached to either the trailer frame or vertical stanchion; location depending on stanchion and/or bow design. The Adjustable member attaches to the base with a horizontal pin or bolt and is adjustable in a fore and aft arc. The Mast is attached to the Adjustable member and extends vertical above the bow. With the boat on the trailer in its “parked” position, the Adjustable member is adjusted so the Mast touches the point of the bow, just as the garage ball was adjusted to touch the cars windshield.

The use of the invention eliminates all previously stated loading problems The operator now has a constantly visible aiming point and a fixed object to judge distance (see FIG. 5).

### BRIEF DESCRIPTION OF THE DRAWINGS

FIG. 1 is a drawing of the Forward Visual Loading Guide (FVLG)

FIG. 2 is a typical boat trailer

FIG. 3 is boat operators view approaching the trailer

FIG. 4 is boat operators view as the boat moves onto the trailer

FIG. 5 is boat operators view as the boat moves onto the trailer with FVLG installed on trailer.

FIG. 6a is side view of boat/trailer in loaded position with FVLG installed on trailer frame. FIG. 6b is same view with FVLG mounted on stanchion.

### DETAILED DESCRIPTION OF THE DRAWINGS

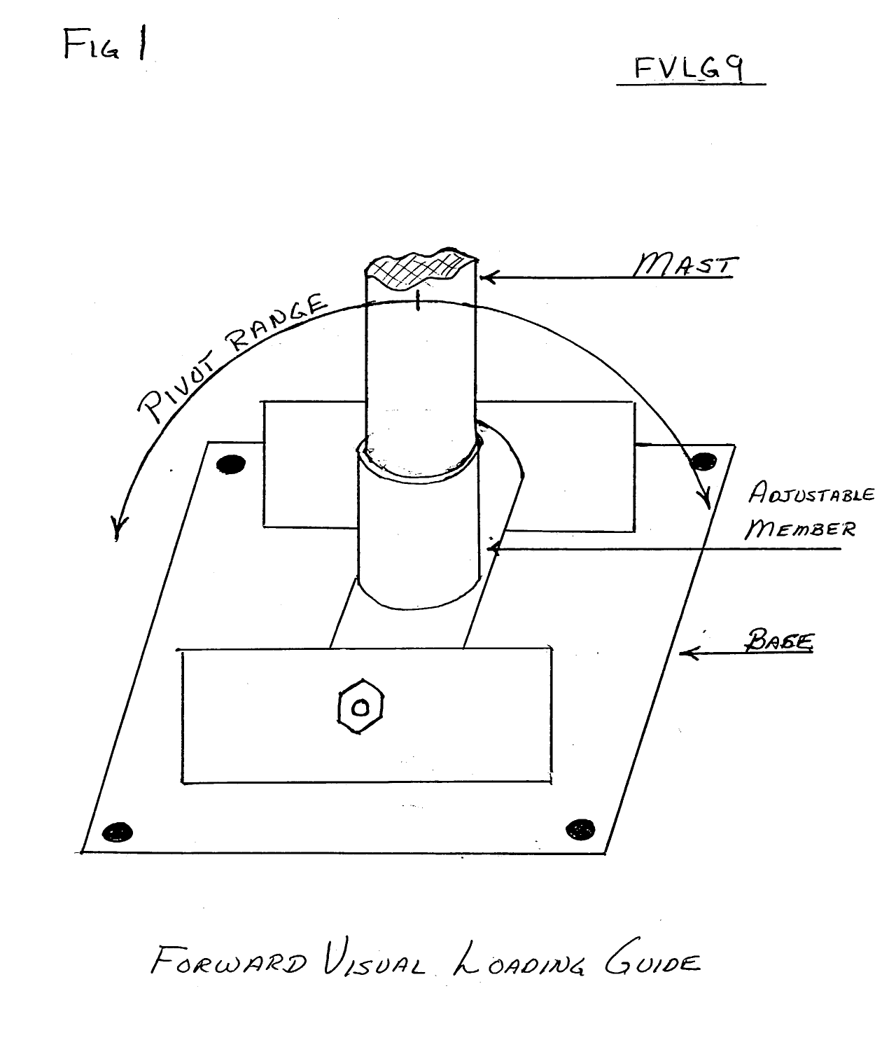

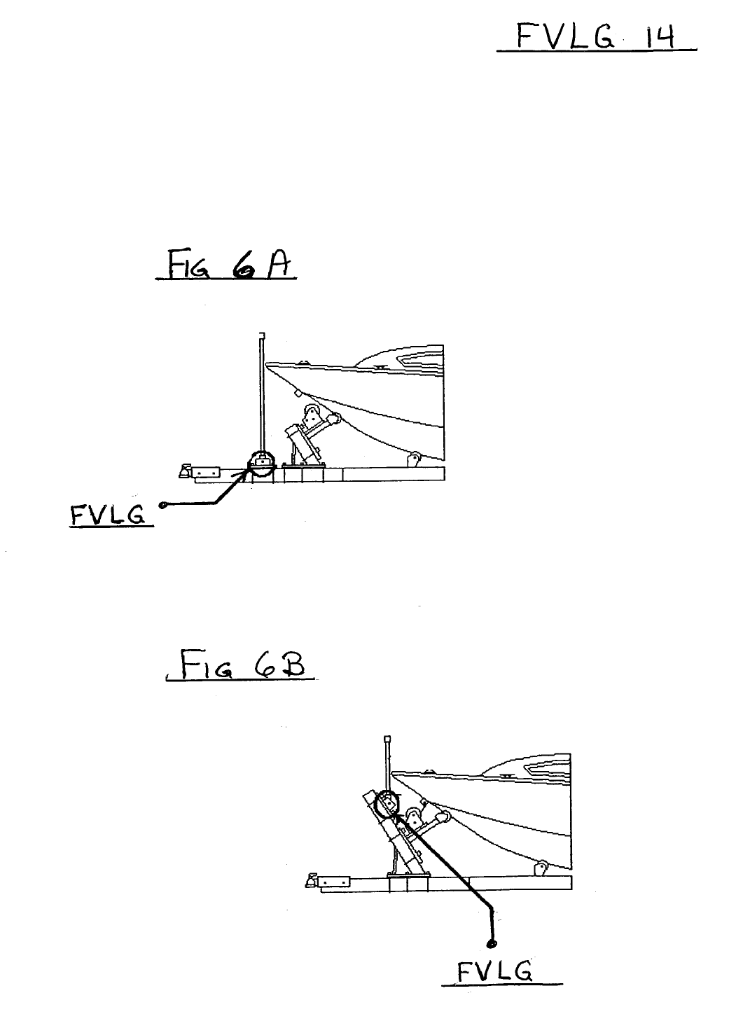

FIG. 1 is a drawing of the invention, referred to as FVLG (Forward Visual Loading Guide) for the sake of identification. The invention consists of: 1) a Base, which is mounted to the trailer, 2) an Adjustable member, and 3) the Mast. The Adjustable member is required to accommodate any mounting requirements and/or boat style. See FIGS. 6a&b.

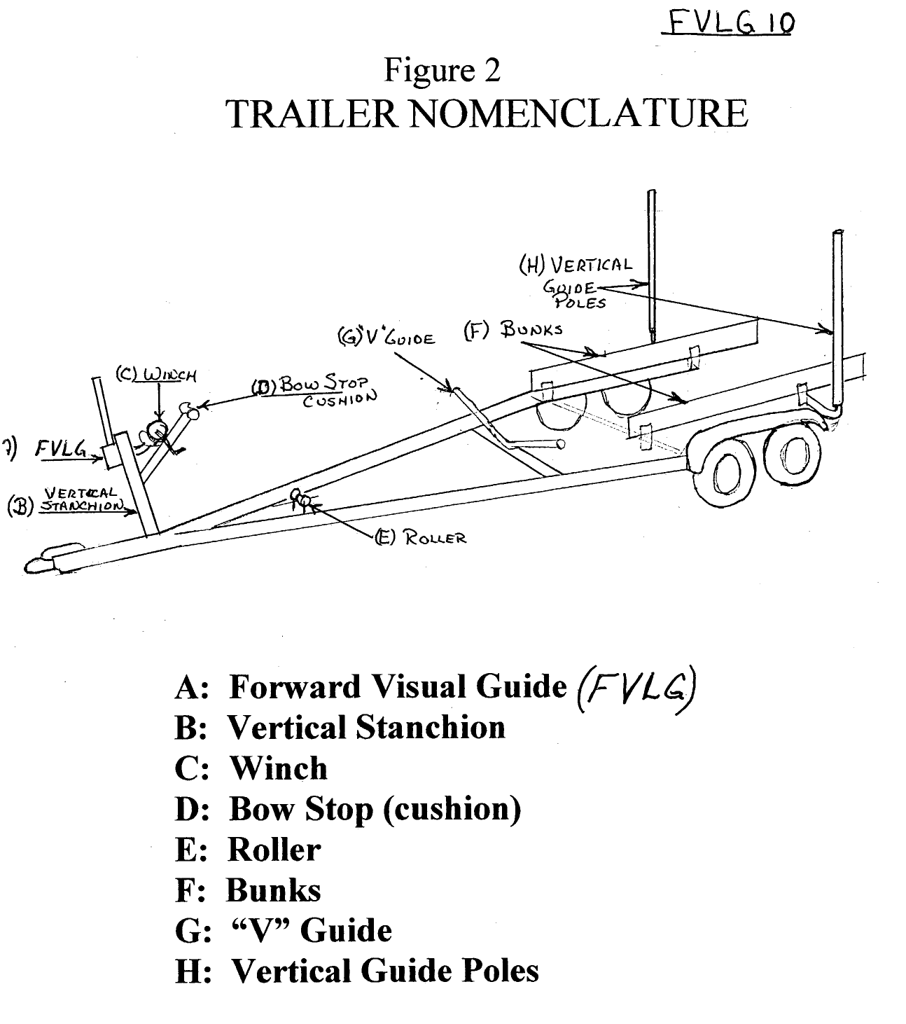

FIG. 2 is a typical boat trailer. (A) is the invention (FVLG), which can be mounted to either the trailer frame or the vertical stanchion (B). The stanchion is the central aim point for the boat operator as the boat approaches the trailer for loading. Attached to the stanchion is the winch (C).

A cable or strap is attached to the winch and is used to pull the boat onto the trailer during manual loading. When the boat is in its loaded position on the trailer, the winch is locked and prevents the boat from sliding backward on the trailer. Also attached to the stanchion is the bow stop cushion (D). In the parked position, the bow of the boat is tight to the cushion. The cushion, is usually adjustable to accommodate various boats with different bow configurations. The roller (E) is used to support the boat on the trailer. Rollers can be used in various configurations to support part or all of the boat. The bunks (F) are often used in conjunction with rollers to support the boat. Bunks have gained popularity because they provide a more even load distribution to the hull and minimize hull distortion during transport and storage. Bunks are usually covered with carpet to allow the hull to slide during loading. A V-guide (G) can be mounted to the trailer frame. It is intended to help provide centering to the boat as it moves onto the trailer. The V-guide is usually covered with PVC to allow the hull slide. The (H) vertical guides serve two main purposes. The rear of the trailer is submerged during loading which makes centering the boat to the trailer difficult. The vertical guides extend above the water and allow the operator to aim the boat between them. As the boat passes through the guides, they keep the rear of the boat centered. The invention (FVLG) visually helps the operator center the bow to the vertical stanchion and tells the driver when the boat has reached the “stop” point.

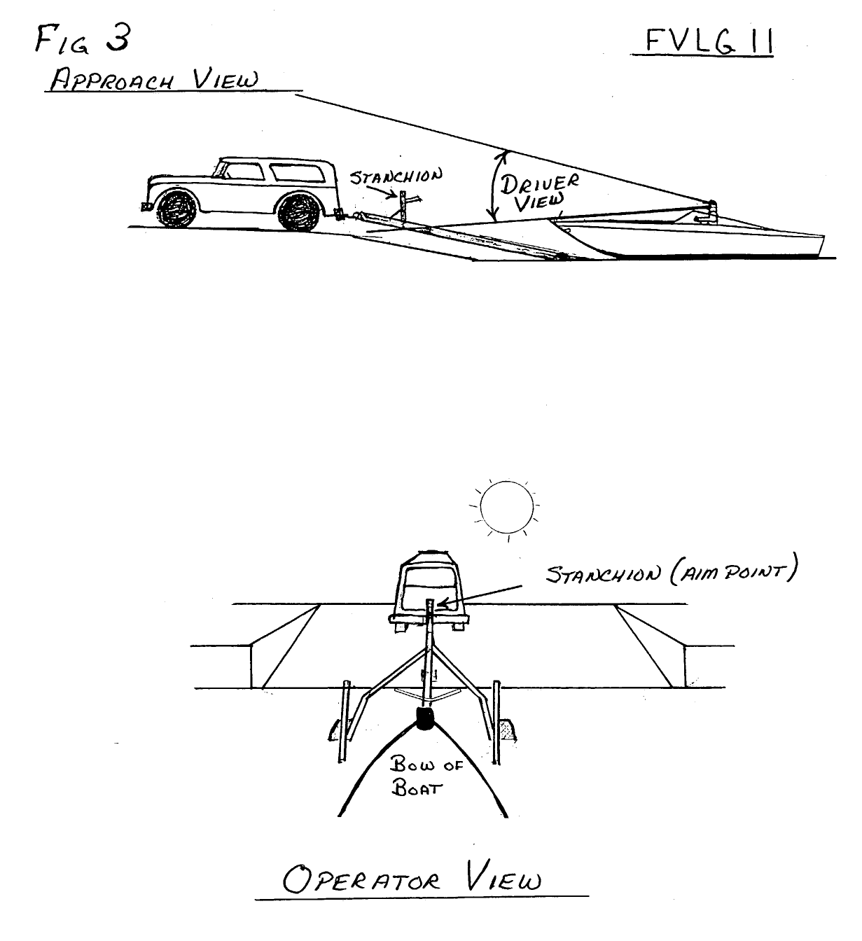

FIG. 3 is the boat operators view approaching the rear of the trailer. Note the vertical stanchion is visible at this point in the loading operation and can be used by the operator to aim the boat to the trailer. The vertical guides are visible and the operator will drive the boat between them.

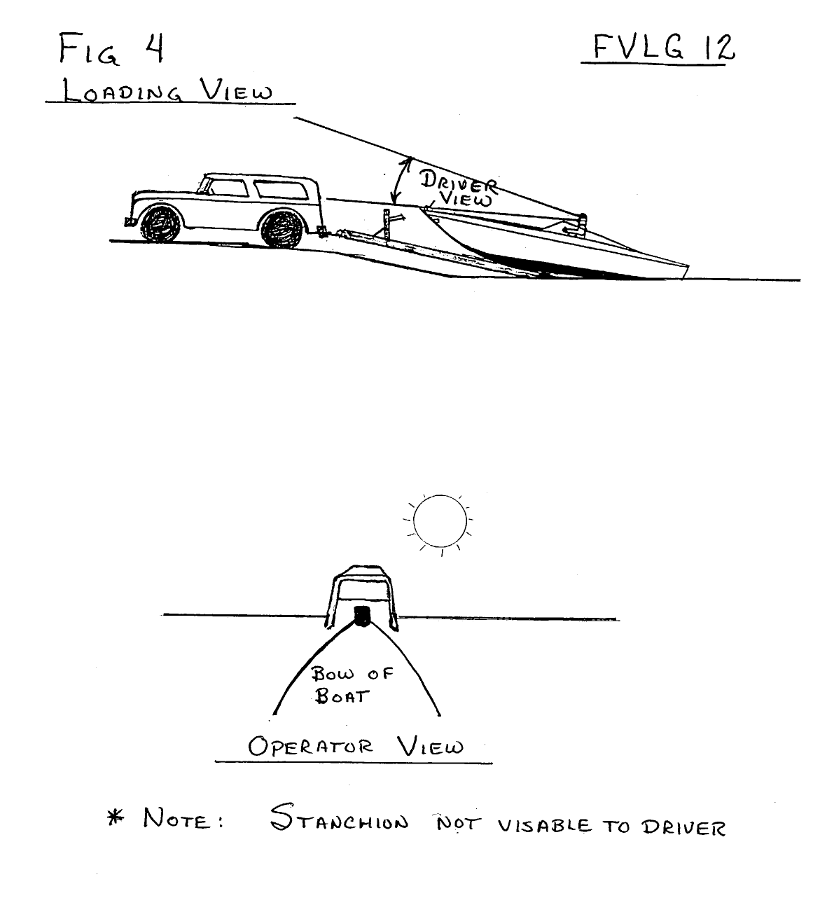

FIG. 4 is the boat operators view as the boat moves on the trailer. Note that the operator has lost any visual reference of bow centering or distance prior to reaching the stop point.

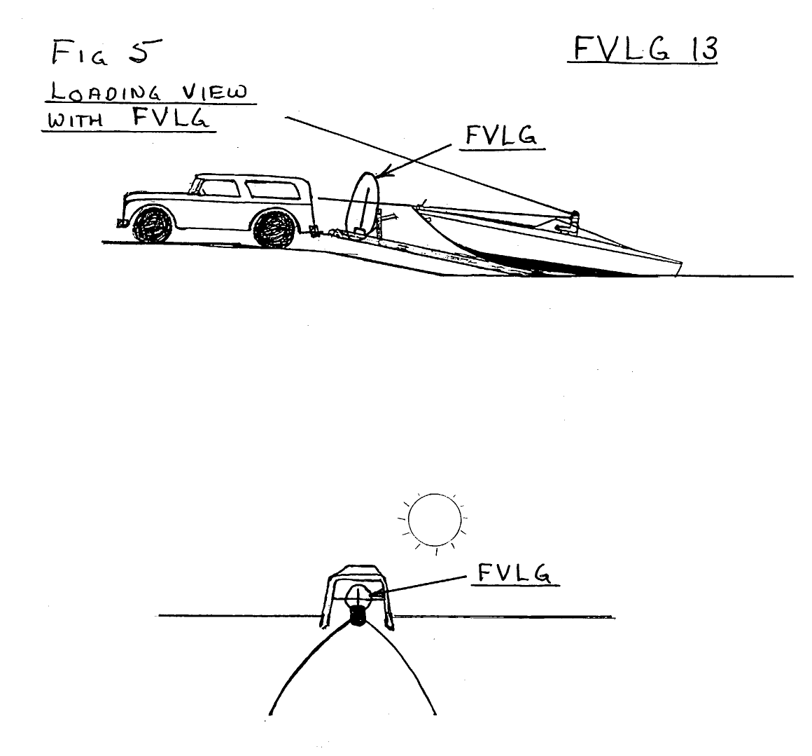

FIG. 5 is the same view as FIG. 4, but the invention (FVLG) is in place. The operator now has a constant visual reference for both bow centering and when to cut engine power when the boat reaches its stop point on the trailer. This is a visual representation of the invention function and purpose.

FIG. 6a shows boat in parked position on trailer with frame-mounted invention (FVLG).

FIG. 6b is same view with stanchion-mounted invention (FVLG)

1. A mechanical device mounted on the front of a boat trailer which provides a means of forward visual reference to the driver of a boat when loading a boat from the water onto a trailer comprising:
(a) a base having predetermined dimensions and material composition
(b) an adjustable member of predetermined dimensions and material composition attached to said base which provides a means of fore and aft position adjustment of
(c) a vertical mast of predetermined dimensions and material composition attached to said adjustable member
